(19) United States
(12) Patent Application Publication
(10) Pub. No.: US 2026/0019911 A1
(43) Pub. Date: Jan. 15, 2026

(54) BASE STATION AND TERMINAL

(71) Applicant: NTT DOCOMO, INC., Tokyo (JP)

(72) Inventors: Tianyang MIN, Tokyo (JP); Shoki INOUE, Tokyo (JP); Riki OKAWA, Tokyo (JP)

(73) Assignee: NTT DOCOMO, INC., Tokyo (JP)

(21) Appl. No.: 18/995,451

(22) PCT Filed: Jul. 20, 2022
(86) PCT No.: PCT/JP2022/028268

§ 371 Date: Jan. 16, 2025

(51) Int. Cl. H04W 36/32; H04W 36/00

(52) U.S. Cl. CPC H04W 36/322; H04W 36/0061

(57) ABSTRACT

A base station includes: a control unit that controls handovers of terminals, which are located in a first cell formed by a network located above a ground, to a second cell adjacent to the first cell; and a transmitting unit that transmits a handover command to the terminals, the handover command being transmitted preferentially to a terminal whose distance from a reference position in the second cell to the terminal is shorter than a threshold value.

### TECHNICAL FIELD

The present disclosure relates to a base station and a terminal.

### BACKGROUND ART

The 3rd Generation Partnership Project (3GPP, registered trademark) specifies the 5th generation mobile communication system (also referred to as 5G, New Radio (NR), or Next Generation (NG)), and is also promoting next-generation specifications called Beyond 5G, 5G Evolution, or 6G.

In 3GPP Release 18, enhancements to mobility and services in NTN (Non-Terrestrial Network) and TN (Terrestrial Network) are being studied (Non-Patent Literature 1).

The TN is a network that includes a gNB (base station) and a UE (user Equipment: terminal), and TN cells are formed by the TN. The NTN is a network in which at least some of devices that constitute the NTN are located above the TN, and NTN cells are formed by the NTN. The NTN is a network that can provide services to areas (such as sea) that cannot be covered by the TN cells for reasons such as cost, by using radio relay devices in the sky.

### CITATION LIST

### Non-Patent Literature

[Non Patent Literature 1] “Revised WID: NR NTN (Non-Terrestrial Networks) enhancements”, RP-221819, 3GPP TSG RAN Meeting #96, Budapest, Hungary, Jun. 6-9, 2022

### SUMMARY OF INVENTION

As a coverage area of the NTN cells moves on a surface of the ground along with a movement of the NTN, a UE which stays in a handover source NTN cell (source cell) needs to perform a handover to a handover destination NTN cell (target cell) adjacent to the source cell. However, in the conventional technology, when a large number of UEs simultaneously perform handovers from the source cell to the target cell as the coverage area of the NTN cells moves, there is a possibility that a signaling overhead of a handover command, a RACH, and the like increases. As the result, frequency and time resources are wasted, and a communication delay may become longer due to this.

Therefore, the following disclosure has been made in light of such a situation, and aims to provide a base station and a terminal capable of suppressing an increase in a signaling overhead due to a handover.

An aspect of the disclosure is a base station including: a control unit that controls handovers of terminals, which are located in a first cell formed by a network located above a ground, to a second cell adjacent to the first cell; and a transmitting unit that transmits a handover command to the terminals, the handover command being transmitted preferentially to a terminal whose distance from a reference position in the second cell to the terminal is shorter than a threshold value.

An aspect of the disclosure is a base station including: a control unit that controls a handover of a terminal, which is located in a first cell formed by a network located above a ground, to a second cell adjacent to the first cell; and a transmitting unit that transmits a back off instruction that suppresses the handover of the terminal to the second cell for a certain period of time.

An aspect of the disclosure is a terminal including: a control unit that controls a handover of the terminal, which is located in a first cell formed by a network located above a ground, to a second cell adjacent to the first cell; and a receiving unit that receives a handover command, the handover command being transmitted preferentially to a terminal whose distance from a reference position in the second cell to the terminal is shorter than a threshold value.

An aspect of the disclosure is a terminal including: a control unit that controls a handover of the terminal, which is located in a first cell formed by a network located above a ground, to a second cell adjacent to the first cell; and a receiving unit that receives a back off instruction that suppresses the handover of the terminal to the second cell for a certain period of time

### BRIEF DESCRIPTION OF DRAWINGS

FIG. 1 is an overall schematic configuration diagram of a radio communication system 10 according to the embodiment.

FIG. 2 is a diagram illustrating frequency ranges used in the radio communication system 10.

FIG. 3 is a diagram illustrating a configuration example of a radio frame, a subframe, and a slot used in the radio communication system 10.

FIG. 4 is a functional block configuration diagram of a UE 200.

FIG. 5 is a functional block configuration diagram of a gNB 100.

FIG. 6 is a diagram illustrating protocols.

FIG. 7 is a diagram illustrating operation example 1 and operation example 2.

FIG. 8 is a diagram illustrating an example of sub-areas into which the source cell is divided.

FIG. 9 is a diagram illustrating an example of communication sequence in the operation example 1.

FIG. 10 is a diagram illustrating an example of communication sequence in the operation example 3.

FIG. 11 is a diagram illustrating an example of communication sequence in the operation example 4.

FIG. 12 is a diagram illustrating an example of a hardware configuration of the gNB 100 and the UE 200.

FIG. 13 is a diagram illustrating a configuration example of a vehicle 2001.

### MODES FOR CARRYING OUT THE INVENTION

Hereinafter, an embodiment will be described based on the drawings. Note that, the same functions and configurations are denoted by the same or similar reference signs, and their descriptions will be omitted as appropriate.

### Embodiment

### (1) Overall Schematic Configuration of Radio Communication System 10

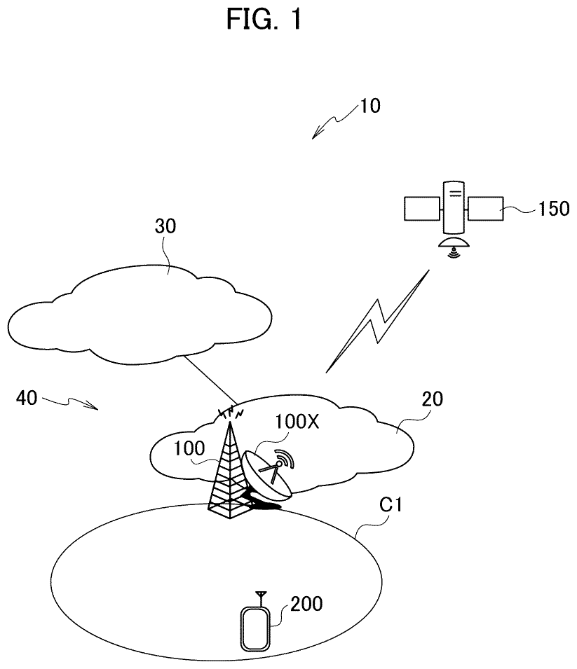

FIG. 1 is an overall schematic configuration diagram of a radio communication system 10 according to the embodiment. The radio communication system 10 is a radio communication system according to 5G New Radio (NR), and includes a Next Generation-Radio Access Network 20 (hereinafter, NG-RAN 20) and a terminal 200 (hereinafter, UE 200, User Equipment, UE). Note that the radio communication system 10 may be a radio communication system that conforms to a system called Beyond 5G, 5G Evolution, or 6G. The radio communication system 10 includes a gNB 100, the UE 200, the NG-RAN 20, and a core network 30.

The NG-RAN 20 includes the radio base station 100 (hereinafter, gNB 100). The NG-RAN 20 actually includes multiple NG-RAN Nodes, specifically, gNBs (or ng-eNBs), and is connected to the core network 30 (e.g., 5GC) according to 5G. Note that, the NG-RAN 20 and the core network 30 may be simply expressed as a “network”. The specific configuration of the radio communication system 10 including the gNB 100 and the UE 200 is not limited to that of the example illustrated in FIG. 1.

The gNB 100 is a radio base station according to 5G, and performs radio communication with the UE 200 according to 5G. The gNB 100 and the UE 200 can be compatible with Massive MIMO (Multiple-Input Multiple-Output) that generates a beam BM with higher directivity by controlling radio signals to be transmitted from multiple antenna elements, carrier aggregation (CA) that uses multiple component carriers (CCs) in a bundle, dual connectivity (DC) that communicates with two or more transport blocks at the same time between the UE and each of two NG-RAN Nodes, and the like.

The core network 30 includes network devices. The network devices may include an LMF (Location Management Function), an AMF (Access and Mobility management Function), and the like. The network devices may include an E-SMLC (Evolved Serving Mobile Location Centre). The gNB 100 forms a radio communication node 40.

In the embodiment, the radio communication system 10 includes a non-terrestrial network (NTN). In the NTN, services are provided to areas that cannot be covered by a terrestrial network (TN) for reasons such as cost, by using an artificial satellite 150 (hereinafter referred to as “satellite 150”) or the like. In addition to the satellite 150, the NTN may include a HAPS (High Altitude Platform Station). The HAPS may include an airship, a balloon, a drone, and the like.

A network that includes the gNB 100 and the UE 200 but not the satellite 150 and the like, may be referred to as a terrestrial network (TN) in contrast to the NTN. The TN may be interpreted as a first network that is formed above the ground or on a surface of the ground. The TN may be interpreted as a first network that is formed near the ground or near the surface of the ground.

The NTN may be interpreted as a second network in which at least some of devices that constitute the NTN are located above the TN. The NTN may be interpreted as a second network located above the TN. The NTN may be interpreted as a second network in which at least some of devices that constitute the NTN are located above the TN, on the basis of the surface of the ground.

The NTN can provide more reliable services. For example, the NTN is expected to be applied to IOT (Inter of things), a ship, a bus, a train, and a critical communication. The NTN has scalability through efficient multicast or broadcast.

A network that includes the gNB 100 and the UE 200 but not the satellite 150 and the like, may be referred to as a terrestrial network (TN) in contrast to the NTN.

The gNB 100 has an NTN gateway 100X. The NTN gateway 100X transmits a downlink signal to the satellite 150. The NTN gateway 100X receives an uplink signal from the satellite 150. The gNB 100 has a cell C1 as its coverage area. The gNB 100 may also have a cell (not illustrated) adjacent to the cell C1 as its coverage area.

The satellite 150 relays to the UE (not illustrated), the downlink signal received from the NTN gateway 100X. The satellite 150 relays to the NTN gateway 100X, the uplink signal received from the UE (not illustrated). The satellite 150 may be considered to be a TRP (Transmission-Reception Point).

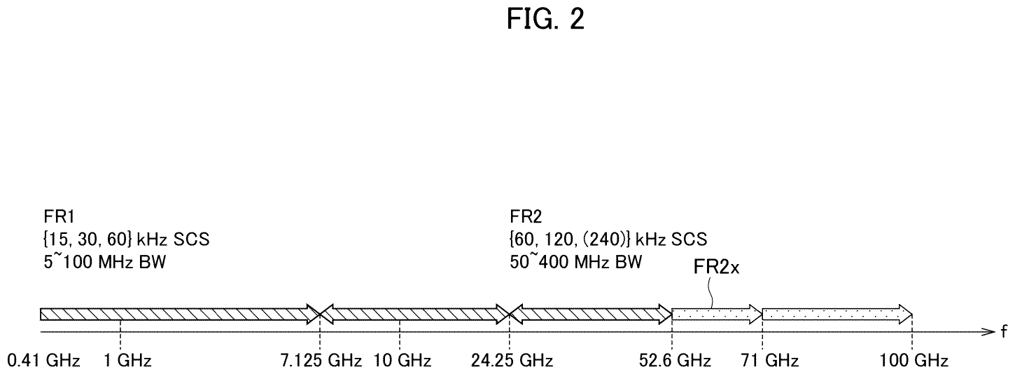

In addition, the radio communication system 10 is compatible with multiple frequency ranges (FRs). FIG. 2 illustrates frequency ranges used in the radio communication system 10.

As illustrated in FIG. 2, the radio communication system 10 may be compatible with multiple frequency ranges (FRs). Specifically, it may be compatible with the following frequency ranges.
FR1: 410 MHz to 7.125 GHz
FR2: 24.25 GHz to 52.6 GHz

In the FR1, a Sub-Carrier Spacing (SCS) of 15, 30, or 60 kHz may be used, and a bandwidth (BW) of 5 to 100 MHz may be used. The FR2 has higher frequencies than the FR1. An SCS of 60 or 120 kHz (may include 240 kHz) may be used, and a bandwidth (BW) of 50 to 400 MHz may be used.

Note that the SCS may be interpreted as numerology. The numerology is defined in 3GPP TS 38.300 and corresponds to one Sub-Carrier Spacing in a frequency domain.

Furthermore, the radio communication system 10 is also compatible with a higher frequency band than the FR2 frequency band. Specifically, the radio communication system 10 is compatible with a frequency band higher than 52.6 GHz and up to 71 GHz or 114.25 GHz. Such a high frequency band may be referred to as “FR2x” for convenience.

In order to solve a problem that an effect of phase noise becomes large in a high frequency band, in the case of using a band exceeding 52.6 GHz, Cyclic Prefix-Orthogonal Frequency Division Multiplexing (CP-OFDM)/Discrete Fourier Transform-Spread (DFT-S-OFDM) having a larger Sub-Carrier Spacing (SCS) may be applied. In the case of using a band exceeding 52.6 GHz, Cyclic Prefix-Orthogonal Frequency Division Multiplexing (CP-OFDM)/Discrete Fourier Transform-Spread (DFT-S-OFDM) having a larger Sub-Carrier Spacing (SCS) may be applied.

In addition, as described above, there is a problem that a phase noise between carriers increases in the high frequency band such as the FR2x. For this reason, it may be necessary to use a larger (wider) SCS or a single-carrier waveform. As the SCS becomes larger, a symbol/CP (Cyclic Prefix) period and a slot period become shorter (when 14-symbol/slot structure is maintained).

When the 14-symbol/slot structure is maintained, the symbol period (and the slot period) becomes shorter as the SCS becomes larger (wider). The symbol period may be referred to as a symbol length, a time direction, a time domain or the like. A frequency direction may be referred to as a frequency domain, a resource block, a subcarrier, a BWP (Bandwidth part), or the like.

A frequency resource may include a component carrier, a subcarrier, a resource block (RB), a resource block group (RBG), a BWP (Bandwidth part), and the like. A time resource may include a symbol, a slot, a mini-slot, a sub-frame, a radio frame, a DRX (Discontinuous Reception) period, and the like.

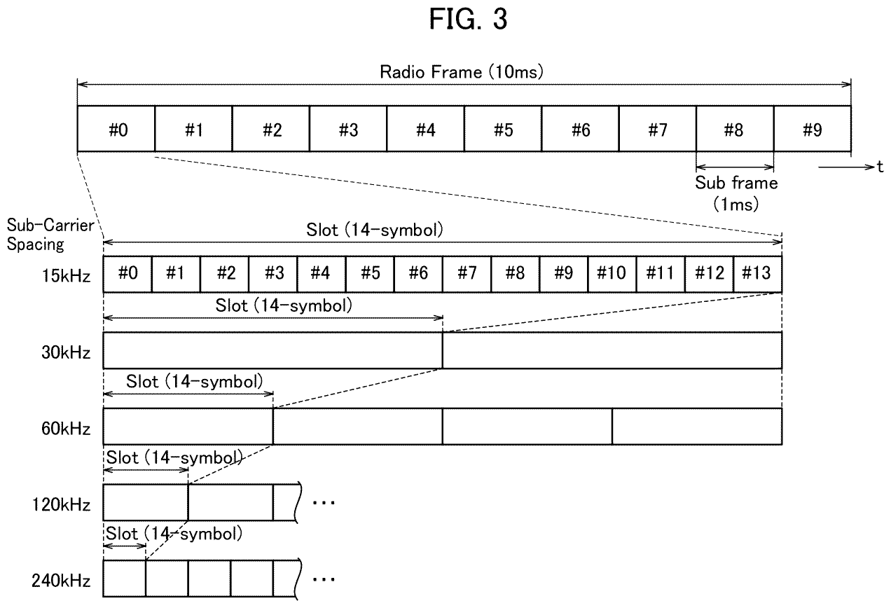

FIG. 3 is a diagram illustrating a configuration example of a radio frame, a subframe, and a slot used in the radio communication system 10.

As illustrated in FIG. 3, one slot includes 14 symbols, and the symbol period (and the slot period) becomes shorter as the SCS becomes larger (wider). The SCS is not limited to intervals (frequencies) illustrated in FIG. 3. For example, 480 kHz, 960 kHz, or the like may be used.

In addition, the number of symbols constituting one slot is not necessarily 14 symbols (for example, 28 symbols or 56 symbols). Furthermore, the number of slots per subframe may be different depending on the SCS.

Note that a time direction (t) illustrated in FIG. 3 may be referred to as a time domain, a symbol period, a symbol time, or the like. In addition, a frequency direction may be referred to as a frequency domain, a resource block, a subcarrier, a Bandwidth part (BWP), or the like.

A DMRS is a kind of reference signal, and is prepared for various channels. Here, unless otherwise specified, it may mean a DMRS for a downlink data channel, specifically, a PDSCH (Physical Downlink Shared Channel). Note that a DMRS for an uplink data channel, specifically, a PUSCH (Physical Uplink Shared Channel), may be construed as being similar to the DMRS for the PDSCH.

The DMRS may be used for channel estimation at the UE 200 as part of a device, for example, coherent demodulation. The DMRS may exist only in a resource block (RB) used for PDSCH transmission.

The DMRS may have multiple mapping types. Specifically, the DMRS has a mapping type A and a mapping type B. In the mapping type A, a first DMRS is allocated to a second or third symbol of a slot. In the mapping type A, the DMRS may be mapped on a basis of a boundary between slots regardless of where in a slot actual data transmission starts. A reason why the first DMRS is allocated to the second or third symbol of the slot may be construed as for the purpose of allocating the first DMRS after control resource sets (CORESET).

In the mapping type B, the first DMRS may be allocated to a first symbol of data allocation. In other words, a position of the DMRS may be given relatively to a location where data is allocated, not to a boundary between slots.

Furthermore, the DMRS may have multiple types. Specifically, the DMRS has a Type 1 and a Type 2. The Type 1 and the Type 2 are different from each other in mapping and the maximum number of orthogonal reference signals in the frequency domain. The Type 1 can output up to four orthogonal signals in a single-symbol DMRS, and the Type 2 can output up to eight orthogonal signals in a double-symbol DMRS.

### (2) Functional Block Configuration of Radio Communication System 10

Next, a functional block configuration of the radio communication system 10 will be described.

First, a functional block configuration of the UE 200 will be described.

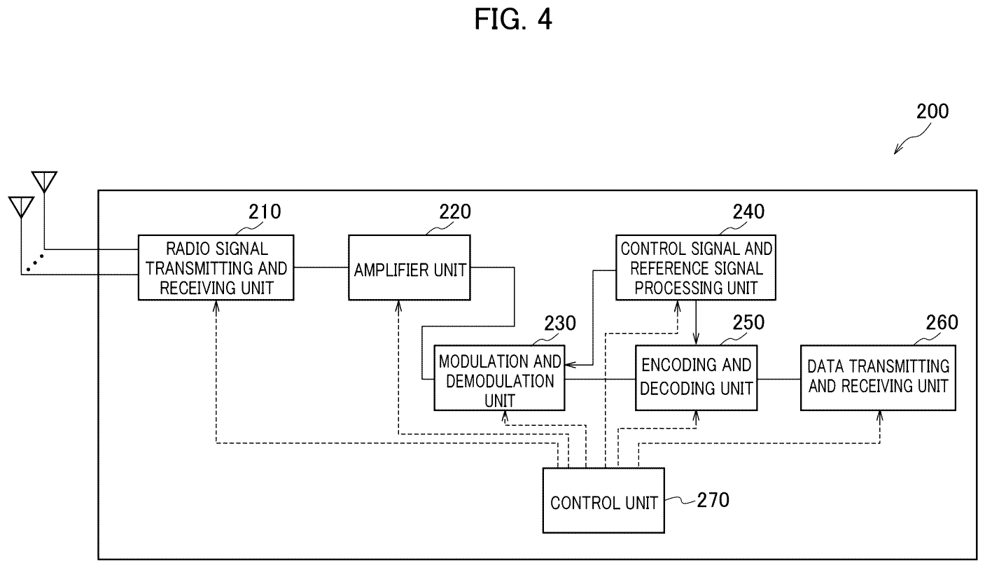

FIG. 4 is a functional block configuration diagram of the UE 200. As illustrated in FIG. 4, the UE 200 includes a radio signal transmitting and receiving unit 210, an amplifier unit 220, a modulation and demodulation unit 230, a control signal and reference signal processing unit 240, an encoding and decoding unit 250, a data transmitting and receiving unit 260, and a control unit 270.

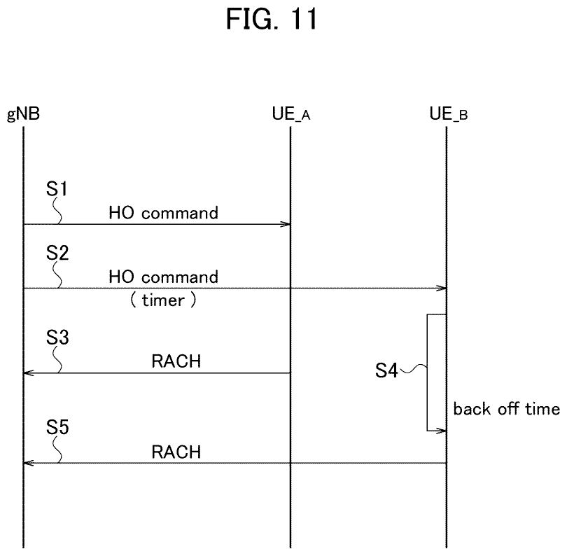

Note that FIG. 4 illustrates only main functional blocks related to the descriptions of the embodiment, and that the UE 200 has other functional blocks (e.g., a power supply unit and the like). Also, FIG. 4 illustrates the functional block configuration of the UE 200, and for the hardware configuration of the UE 200, refer to FIG. 11.

The radio signal transmitting and receiving unit 210 transmits and receives a radio signal according to NR. The radio signal transmitting and receiving unit 210 deals with Massive MIMO in which a more directional beam is generated by controlling radio (RF) signals to be transmitted from multiple antenna elements, a carrier aggregation (CA) in which multiple component carriers (CCs) are bundled and used, a dual connectivity (DC) in which communication is simultaneously performed between the UE 200 and each of two NG-RAN Nodes, and the like.

The amplifier unit 220 includes a PA (Power Amplifier)/LNA (Low Noise Amplifier) and the like. The amplifier unit 220 amplifies a signal output from the modulation and demodulation unit 230 to a predetermined power level. In addition, the amplifier unit 220 amplifies an RF signal output from the radio signal transmitting and receiving unit 210.

The modulation and demodulation unit 230 executes data modulation and demodulation, transmission power setting, resource block assignment, and the like for each predetermined communication destination (gNB 100 or another gNB). In the modulation and demodulation unit 230, Cyclic Prefix-Orthogonal Frequency Division Multiplexing (CP-OFDM)/Discrete Fourier Transform-Spread (DFT-S-OFDM) may be applied. Further, DFT-S-OFDM may be used not only for uplink (UL) but also for downlink (DL).

The control signal and reference signal processing unit 240 executes processing related to various control signals transmitted and received by the UE 200, and processing related to various reference signals transmitted and received by the UE 200.

Specifically, the control signal and reference signal processing unit 240 receives various control signals transmitted from the gNB 100 via a predetermined control channel, for example, a control signal of a radio resource control layer (RRC). Further, the control signal and reference signal processing unit 240 transmits various control signals to the gNB 100 via a predetermined control channel.

The control signal and reference signal processing unit 240 executes processing using a reference signal (RS) such as a Demodulation Reference Signal (DMRS) and a Phase Tracking Reference Signal (PTRS). The DMRS is a known specific reference signal (pilot signal) for the UE 200 between the base station and the UE 200 for estimating a phasing channel to be used for data demodulation. The PTRS is a specific reference signal for the UE 200 designed for the purpose of estimating a phase noise that is a problem in a high frequency band.

Note that, the reference signal may include a Channel State Information-Reference Signal (CSI-RS), a Sounding Reference Signal (SRS), and a Positioning Reference Signal (PRS) for position information, in addition to the DMRS and the PTRS.

In addition, the channel includes a control channel and a data channel. The control channel includes a PDCCH (Physical Downlink Control Channel), a PUCCH (Physical Uplink Control Channel), a RACH (Random Access Channel), Downlink Control Information (DCI) including a Random Access Radio Network Temporary Identifier (RA-RNTI), a Physical Broadcast Channel (PBCH), and the like.

In addition, the data channel includes a PDSCH (Physical Downlink Shared Channel), a PUSCH (Physical Uplink Shared Channel), and the like. Data means data transmitted via the data channel. The data channel may be interchanged with a shared channel.

The control signal and reference signal processing unit 240 may receive downlink control information (DCI). The DCI includes, as existing fields, fields for storing DCI Formats, Carrier indicator (CI), BWP indicator, FDRA (Frequency Domain Resource Assignment), TDRA (Time Domain Resource Assignment), MCS (Modulation and Coding Scheme), HPN (HARQ Process Number), NDI (New Data Indicator), RV (Redundancy Version), and the like.

A value stored in the DCI Format field is an information element specifying the format of the DCI. A value stored in the CI field is an information element specifying a CC for which the DCI is applied. A value stored in the BWP indicator field is an information element specifying a BWP for which the DCI is applied. The BWP that can be specified by the BWP indicator is configured by an information element (BandwidthPart-Config) included in an RRC message. A value stored in the FDRA field is an information element specifying a frequency domain resource for which the DCI is applied. The frequency domain resource is identified by a value stored in the FDRA field and an information element (RA Type) included in the RRC message. A value stored in the TDRA field is an information element specifying a time domain resource for which the DCI is applied. The time domain resource is identified by a value stored in the TDRA field and an information element (pdsch-TimeDomainAllocationList, pusch-TimeDomainAllocationList) included in the RRC message. The time domain resource may be identified by a value stored in the TDRA field and a default table. A value stored in the MCS field is an information element specifying an MCS for which the DCI is applied. The MCS is identified by a value stored in the MCS and an MCS table. The MCS table may be specified by the RRC message, or may be identified by RNTI scrambling. A value stored in the HPN field is an information element specifying a HARQ Process for which the DCI is applied. A value stored in the NDI is an information element for identifying whether data for which the DCI is applied is first transmission data. A value stored in the RV field is an information element specifying redundancy of data for which the DCI is applied.

In the embodiment, the control signal and reference signal processing unit 240 may configure a receiving unit that receives a handover command, the handover command being transmitted preferentially to a terminal whose distance from a reference position in a second cell to the terminal is shorter than a threshold value.

In the embodiment, the control signal and reference signal processing unit 240 may configure a receiving unit that receives a back off instruction that suppresses a handover of the terminal to the second cell for a certain period of time.

In the embodiment, the control signal and reference signal processing unit 240 may configure a receiving unit that receives the handover command, which does not include the back off instruction, transmitted to a terminal whose distance from the reference position in the second cell to the terminal is shorter than the threshold value, or receives the handover command, which includes the back off instruction, transmitted to a terminal for which the distance is longer than the threshold value.

The encoding and decoding unit 250 performs data division and coupling, channel coding and decoding, and the like for each predetermined communication destination (gNB 100 or another gNB). Specifically, the encoding and decoding unit 250 divides data output from the data transmitting and receiving unit 260 into predetermined sizes, and performs channel coding on the divided data. Further, the encoding and decoding unit 250 decodes data output from the modulation and demodulation unit 230 and couples the decoded data.

The data transmitting and receiving unit 260 transmits and receives a Protocol Data Unit (PDU) and a Service Data Unit (SDU). Specifically, the data transmitting and receiving unit 260 performs assembly and disassembly of the PDU and SDU in multiple layers (a media access control layer (MAC), a radio link control layer (RLC), a packet data convergence protocol layer (PDCP), and the like). In addition, the data transmitting and receiving unit 260 executes error correction and retransmission control of data on the basis of HARQ (Hybrid Automatic Repeat Request).

The control unit 270 controls each functional block constituting the UE 200. In the embodiment, the control unit 270 may configure a control unit that controls a handover of a terminal, which is located in a first cell formed by the network located above the ground, to the second cell adjacent to the first cell.

In the radio communication system 10, an SSB (SS/PBCH Block) including a synchronization signal (SS: Synchronization Signal) and a downlink physical broadcast channel (PBCH: Physical Broadcast Channel) may be used.

The SSB is mainly transmitted from the network at intervals such that the UE 200 can detect a cell ID and a reception timing at the start of communication. In NR, the SSB is also used to measure reception quality of each cell. A transmission period (periodicity) of the SSB may be specified as 5, 10, 20, 40, 80, or 160 milliseconds. Note that the UE 200 in an initial access may be assumed to have a transmission period of 20 milliseconds.

Secondly, a functional block configuration of the gNB 100 will be described.

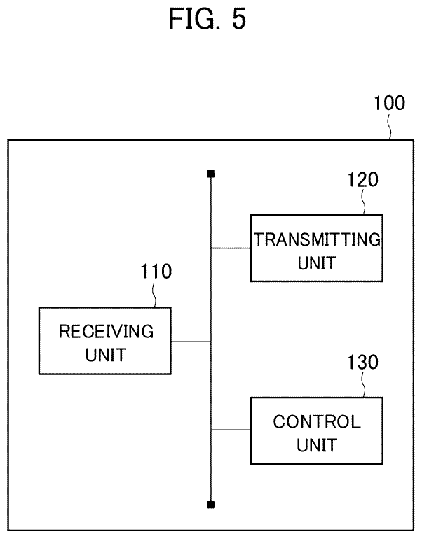

FIG. 5 is a functional block configuration diagram of the gNB 100. As illustrated in FIG. 5, the gNB 100 includes a receiving unit 110, a transmitting unit 120, and a control unit 130.

The receiving unit 110 receives various signals from the UE 200. The receiving unit 110 may receive a UL signal via the PUCCH or the PUSCH.

The transmitting unit 120 transmits various signals to the UE 200. The transmitting unit 120 may transmit a DL signal via the PDCCH or the PDSCH. The transmission unit 120 may transmit two or more DL-PRS (Downlink Positioning Reference Signal) at different timings on a time axis via the NTN.

In the embodiment, the transmitting unit 120 may configure a transmitting unit that transmits a handover command to the terminals, the handover command being transmitted preferentially to a terminal whose distance from a reference position in a second cell to the terminal is shorter than a threshold value.

In the embodiment, the transmitting unit 120 may configure a transmitting unit that transmits a back off instruction that suppresses a handover of the terminal to the second cell for a certain period of time.

In the embodiment, the transmitting unit 120 may configure a transmitting unit that transmits the handover command, which does not include the back off instruction, to a terminal for which the distance is shorter than the threshold value, or transmits the handover command, which includes the back off instruction, to a terminal for which the distance is longer than the threshold value.

The control unit 130 controls the gNB 100. In the embodiment, the control unit 130 may configure a control unit that controls handovers of the terminals, which are located in a first cell formed by the network located above the ground, to the second cell adjacent to the first cell.

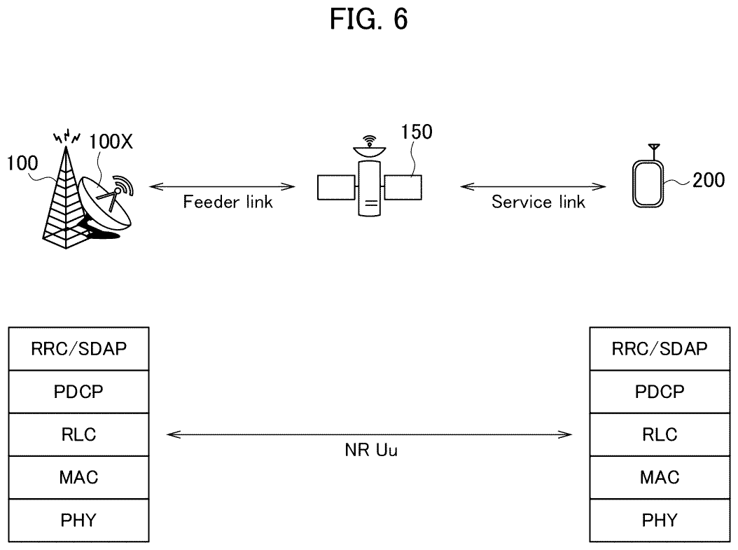

Next, protocols will be described with reference to FIG. 6. FIG. 6 is a diagram illustrating protocols. As illustrated in FIG. 6, the gNB 100 has a protocol stack including PHY, MAC, RLC, PDCP, RRC/SDAP and the like. Similarly, the UE 200 has a protocol stack including PHY, MAC, RLC, PDCP, RRC/SDAP and the like. The satellite 150 relays communication between the gNB 100 and the UE 200.

A link between the gNB 100 (NTN gateway 100X) and the satellite 150 may be referred to as Feeder link. A link between the satellite 150 and the UE 200 may be referred to as Service link. An interface between the gNB 100 and the UE 200 may be referred to as NR Uu.

Note that it may be assumed that FFD or TTD is adopted as a network architecture of the NTN. Terrestrial cells may be fixed or mobile. The UE 200 may have a capability to support a GNSS (Global Navigation Satellite System). For the UE 200, a power class 3 handheld device may be assumed for FR1, and VSAT (Very small aperture terminal) may be assumed for at least FR2.

It may be assumed that a regenerative payload may be used as the network architecture of the NTN. For example, functions of the gNB 100 may be installed in a satellite or a flying body. In addition, a gNB-DU (Distributed Unit) may be installed in the satellite or the flying body, and a gNB-CU (Central Unit) may be deployed as a ground station.

### (3) Operation of Radio Communication System 10

Next, operation of the radio communication system 10 will be described. Specifically, operation examples of the radio communication system 10 including the gNB 100 and the UE 200 capable of suppressing an increase in a signaling overhead due to a handover from a target cell of the NTN to a source cell of the NTN.

### (3.1) Premise and Problem

A problem involved in suppressing an increase in a signaling overhead due to a handover, will be described.

As a coverage area of the NTN cells moves on the surface of the ground along with a movement of the NTN which is a network in a sky, a UE staying in a handover source NTN cell (source cell) needs to perform a handover to a handover destination NTN cell (target cell) adjacent to the source cell. However, in the conventional technology, when a large number of UEs simultaneously perform handovers from the source cell to the target cell as the coverage area of the NTN cells moves, there is a possibility that a signaling overhead of a handover command, a RACH, and the like increases. As the result, frequency and time resources are wasted, and a communication delay may become longer due to this.

As a solution of this problem, as will be described below, there are a plurality of operation examples that can suppress the increase in the signaling overhead due to the handover from the target cell of the NTN to the source cell of the NTN. Note that the plurality of operation examples which will be described below, can be used individually or in combination of two or more operation examples.

### (3.2) Operation Examples

The operation examples that can solve the above-described problem will be described below.

### (3.2.1) Operation Example 1

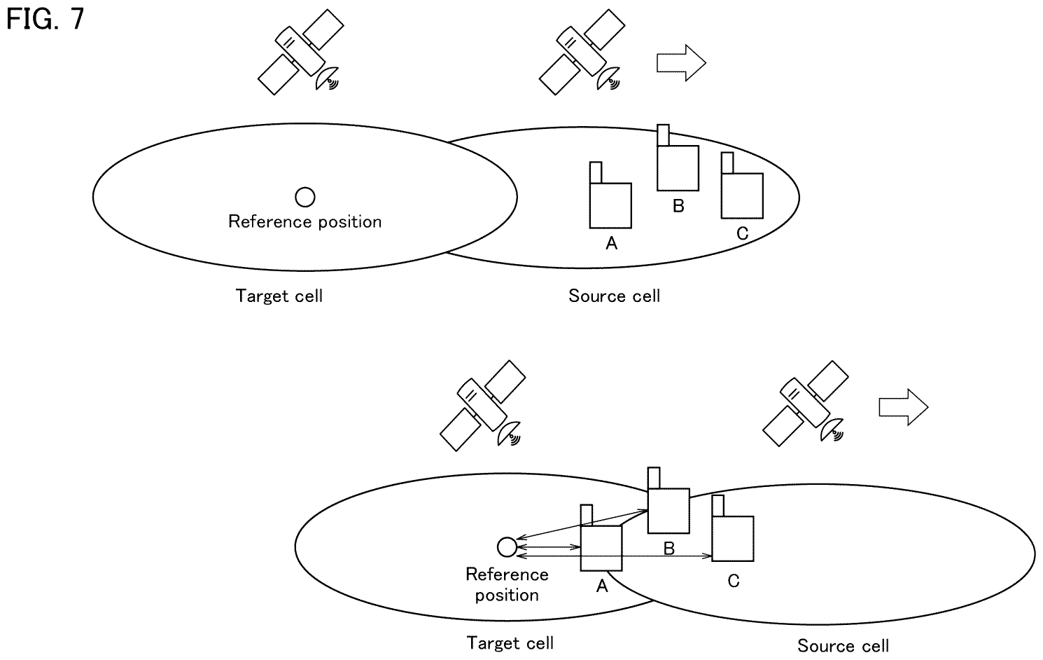

FIG. 7 is a diagram illustrating operation example 1 and operation example 2. FIG. 7 illustrates a source cell formed by the NTN, a target cell adjacent to the source cell, and a plurality of UEs 200 (UE__{A}, UE__{B}, UE__{C}) staying in the source cell. The source cell may be interpreted as a cell formed by a first satellite 150 of a plurality of satellites 150 that configure the NTN. The target cell may be interpreted as a cell formed by a second satellite 150 of the plurality of satellites 150 that configure the NTN.

As these satellites 150 move, a coverage area of cells (NTN cells) formed by the NTN moves on the surface of the ground. For this reason, the plurality of UEs 200 staying in the source cell illustrated in an upper part of FIG. 7 need to perform a handover to the target cell illustrated in a lower part of FIG. 7.

In the operation example 1, when the coverage area of the NTN cells moves, the gNB 100 (source gNB) compares UE location information with a reference position of the target cell, and performs a handover process in order from the UE 200 that is closest to the target cell.

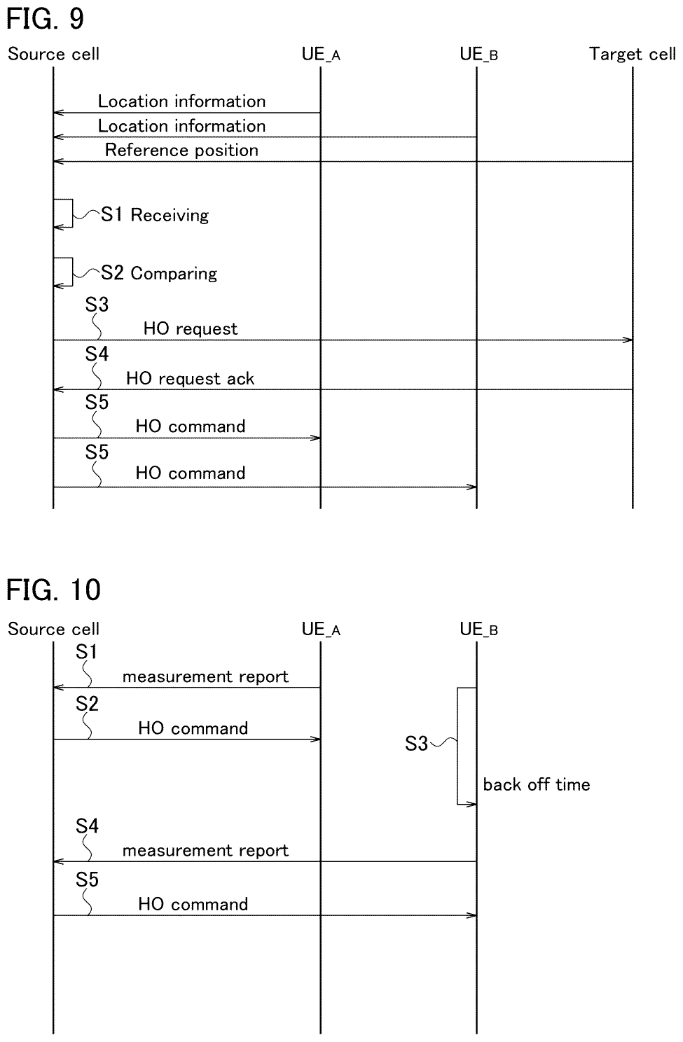

FIG. 9 is a diagram illustrating an example of communication sequence in the operation example 1. The gNB 100 (source gNB) receives a plurality of pieces of location information from the plurality of UEs 200, and receives information indicating a reference position from the target cell (step S1).

The gNB 100 (source gNB) compares a distance between a position of the UE 200 and the reference position of the target cell, with a distance between a position of another UE 200 and the reference position of the target cell (step S2). As a result of the comparison, the gNB 100 may transmit a handover request in order from the UE 200 that is closest to the target cell (step S3).

The reference position of the target cell may be interpreted as a reference position within the second cell (e.g., a center position of the target cell) when the positions of the plurality of UEs 200 are measured, for example. The reference position of the target cell may be interpreted as an Ellipsoid point (see 3GPP TS 37.355 V17.0.0 § 6.5.5.8).

When receiving the handover request from the gNB 100 which is a handover source, the gNB 100 (target gNB) which is a handover destination transmits a handover request acknowledgement (HO request ack) to the gNB (source gNB) 100 which is the handover source, in order in which the handover request was received (step S4). The source gNB 100 may transmit a handover command to one or more UEs 200 in order in which the HO request ack was received (step S5).

Thereby, each of the one or more UEs 200 that have received the handover command, performs a handover from the source cell which is the handover source to the target cell which is the handover destination, based on the handover command.

Specifically, at a timing of receiving the handover command, each of the plurality of UEs 200 may transmit a RACH (Random Access Channel) to the target cell using a RACH resource. As the result, the RACH can be transmitted to the target cell in order from the UE 200 that is closest to the target cell (for example, in order of the UE__{A}, the UE__{B}, and the UE__{C} illustrated in the lower part of FIG. 7).

The above-described NTN cell may be interpreted as a mobile cell. The mobile cell may be interpreted as a Quasi-earth-fixed cell (see 3GPP TSG-RAN WG2 Meeting #112-e, R2-2010765). The mobile cell may be interpreted as an Earth-moving cell (see 3GPP TSG-RAN WG2 Meeting #108, R2-1916240). The mobile cell may be interpreted as a cell formed by the NTN located in the sky.

The above-described UE location information may be interpreted as information indicating a position of each UE 200. The UE location information may be obtained from the measurement report and/or location report reported by each UE 200. The source gNB may be interpreted as the gNB 100 located near the source cell. The target gNB may be interpreted as the gNB 100 located near the target cell.

### (Alt 1)

The source gNB may compare a distance between each of positions of the plurality of UEs 200 and the reference position of the target cell and, as a result of the comparison, include in a handover request information indicating a distance between each of the positions of the plurality of UEs 200 and the reference position. In this case, the target gNB that has received the handover request may transmit a handover request acknowledgement (HO request ack) to the gNB (source gNB) 100 which is the handover source, in order from the UE 200 whose distance from the target cell is shortest, that is, in order from the UE 200 that is closest to the target cell, based on the information included in the handover request. The source gNB 100 may transmit the handover command to each of the plurality of UEs 200 in order in which the HO request ack is received. The plurality of UEs 200 that have received the handover command can transmit RACHs to the target cell in the order of the UE__{A}, the UE__{B}, and the UE__{C}, as illustrated in the lower part of FIG. 7.

According to the operation example 1, a handover to the target cell can be performed in order from the UE 200 that is closest to the target cell, depending on the distance from each of the plurality of UEs 200 to the target cell. In other words, a handover timing of the UE 200 far from the target cell can be delayed than a handover timing of the UE 200 close to the target cell. This prevents the plurality of UEs from simultaneously performing handovers to the target cell, which prevents a signaling overhead of a handover command, a RACH, and the like from increasing in a short period of time. As a result, communication delays can be suppressed without wasting frequency or time resources.

### (3.2.2) Operation Example 2

Operation example 2 describes an example in which a handover process is performed in order from the UE 200 that is closest to the target cell, by determining whether a distance from each of the plurality of UEs 200 to the target cell is shorter than a predetermined threshold value (distance).

If a distance from each of positions of some UEs 200 to the reference position of the target cell is shorter than a predetermined threshold value, the gNB 100 may transmit a handover command preferentially to the UEs 200 for which the distance is shorter than the predetermined threshold value. In other words, the gNB 100 may transmit a handover command to a UE 200 whose distance is longer than the predetermined threshold value after a certain period of time has elapsed since a handover command was transmitted to a UE 200 whose distance is shorter than the predetermined threshold value.

Specifically, the gNB 100 determines whether a distance between a position of each UE 200 to the reference position is shorter than a predetermined threshold value (e.g., 10 km).

More specifically, it is assumed that a distance between each of positions of the UE__{A} and the UE__{B} illustrated in FIG. 7 and the reference position of the target cell is around 8 km, a distance between a position of the UE__{C} and the reference position of the target cell is around 11 km, and the predetermined threshold value is 10 km.

In this case, the gNB 100 determines that the distance to each of the UE__{A} and the UE__{B} is shorter than the predetermined threshold value, and the distance to the UE__{C} is longer than the predetermined threshold value. The gNB 100 transmits a handover command preferentially to the UE__{A} and the UE__{B}, and after a certain period of time has elapsed, transmits a handover command to the UE__{C.}

The UE__{A} and the UE__{B} that have received the handover command, can perform the handover earlier than the UE__{C}, and the UE__{C} can perform the handover later than the UE__{A} and the UE__{B.}

### (Alt 1)

The predetermined threshold value may include different threshold values. Specifically, the predetermined threshold value may include a group A, a group B, a group C, and the like, as threshold values corresponding to distances each from the reference position of the target cell to a position away from the reference position at a predetermined distance.

The group A may be interpreted as a threshold value corresponding to a distance within 10 km from the reference position of the target cell, for example.

The group B may be interpreted as a threshold value corresponding to a distance exceeding 10 km and within 30 km from the reference position of the target cell, for example.

The group C may be interpreted as a threshold value corresponding to a distance exceeding 30 km from the reference position of the target cell.

(Alt 1: Case where Different Threshold Values are Set in gNB 100)

It is assumed that the distances from the reference position of the target cell to the UE__{A}, the UE__{B}, and the UE__{C} are approximately 8 km, 15 km, and 35 km, respectively. The gNB 100 in which the above-described different threshold values are set, determines which of the respective threshold values the distance from the position of each UE 200 to the reference position corresponds to.

In this case, the distance to the UE__{A} corresponds to a first threshold (group A), the distance to the UE__{B}, corresponds to a second threshold (group B), and the distance to the UE__{C} corresponds to a third threshold (group C). For this reason, the gNB 100 transmits the handover command in order of the UE__{A}, the UE__{B}, and the UE__{C}. In this case, a transmission interval of the handover command may be a fixed time, or a time that becomes longer or shorter as the distance to the UE 200 becomes longer. This allows the handover to be performed to the target cell in order from the UE 200 that is closest to the target cell.

(Alt 2: Case where Different Threshold Values are Set in UE 200)

Each UE 200 in which the above-described different threshold values are set, may receive the reference position from the network and then determine which of the threshold values the distance from a position of the UE 200 to the reference position corresponds to. Each UE 200 may set a transmission timing of a measurement report according to a result of the determination.

For example, if the UE__{A} determines that a distance from a position of the UE__{A} to the reference position corresponds to the group A, the UE__{A} transmits a measurement report to the gNB immediately after making the determination.

If the UE__{B} determines that a distance from a position of the UE__{B} to the reference position corresponds to the group B, the UE__{B} transmits a measurement report to the gNB after a first time period has elapsed (after waiting for a specified back off time) from a time when the result of the determination was obtained.

If the UE__{C} determines that a distance from a position of the UE__{C} to the reference position corresponds to the group C, the UE__{C} transmits a measurement report to the gNB after waiting for a back off time longer than the first time period from a time when the result of the determination was obtained.

Thereby, the UE__{A} can receive a handover command preferentially and then transmits a RACH to the target cell earliest. Each of the UE__{B} and the UE__{C} can transmit a RACH to the target cell later than the UE__{A.}

According to the operation example 2, the handover process can be performed in order from the UE 200 that is closest to the target cell, by comparing a distance from each UE 200 to the target cell with the predetermined threshold values. Therefore, in addition to the effect of the operation example 1, even when the number of the UEs 200 each of which is a handover candidate is large, handovers in the gNB 100 and the UEs 200 can be performed promptly.

### (3.2.3) Operation Example 3

In the operation example 1, the handover process is performed by determining a position of each of the plurality of UEs 200 that exist within one source cell. In contrast, in operation example 2, an example in which a handover process is performed by determining a position of each of UEs 200 that exist in any of sub-areas into which the source cell is divided, will be described.

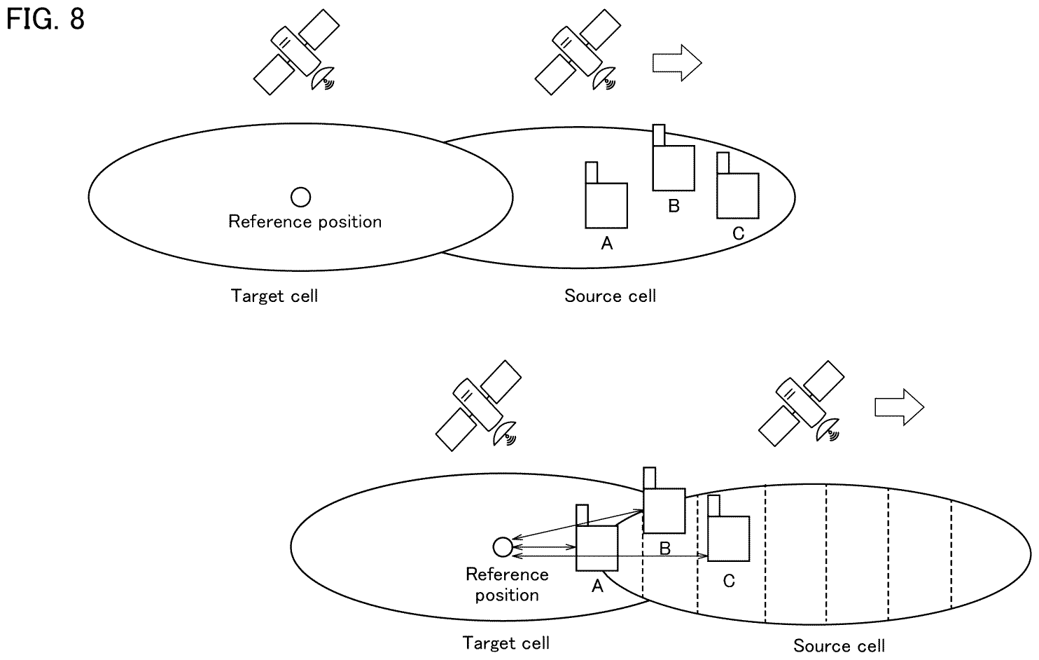

FIG. 8 is a diagram illustrating an example of sub-areas into which the source cell is divided. Information on the sub-areas into which the NTN cell (source cell) is divided as illustrated in FIG. 8, may be set in the gNB 100 or each UE 200.

Specifically, information on the sub-areas that are sub mapped cells or sub geographical areas into which the source cell is divided, may be set in the gNB 100 or each UE 200.

More specifically, information in which the sub-area that is closest to the target cell is associated with sub mapped cell 1, the sub-area that is secondly close to the target cell is associated with sub mapped cell 2, and the sub-area that is thirdly close to the target cell is associated with sub mapped cell 3, may be set in the gNB 100 or each UE 200. In the example in FIG. 8, the UE__{A} stays in the sub mapped cell 1, the UE__{B} stays in the sub mapped cell 2, and the UE__{C} stays in the sub mapped cell 3.

(Alt 1: Case where Information on Sub-Areas is Set in gNB 100)

As illustrated in FIG. 8, when a plurality of UEs 200 stay in the sub-areas, the gNB 100 matches a position of each UE 200 with the information on the sub-areas (for example, information indicating how far each sub-area is from the reference position of the target cell). This allows the gNB 100 to determine which of the sub mapped cells 1 to 3 each UE 200 stays in.

The gNB 100 may transmit a handover command to each UE 200 in order of the UE__{A}, the UE__{B}, and the UE__{C}, based on the result of the determination.

Each UE 200 that receives the handover command can transmit a RACH to the target cell in order of the UE__{A}, the UE__{B}, and the UE__{C}. In other words, a handover can be performed in order from the UE 200 that is closest to the target cell.

Thus, among the sub-areas, the gNB 100 can cause the UE staying in a sub-area close to the target cell, to preferentially perform a handover, and cause the UE 200 staying in a sub-area far from the target cell, to delay a handover.

(Alt 2: Case where Information on Sub-Areas is Set in UE 200)

FIG. 10 is a diagram illustrating an example of communication sequence in the operation example 3. Each UE 200 in which the information on the sub-areas is set, matches a position of the UE 200 with the information on the sub-areas. This allows each UE 200 to determine which of the sub mapped cells 1 to 3 the UE 200 stays in. The plurality of UEs 200 may transmit measurement reports to the gNB in order of the UE__{A}, the UE__{B}, and the UE__{C} based on the result of the determination.

Specifically, if the UE__{A} determines to stay in the sub mapped cell 1, the UE__{A} transmits a measurement report immediately after making the determination (step S1).

When the gNB 100 receives the measurement report, the gNB 100 transmits a handover command to the UE__{A} (step S2).

If the UE__{B} determines to stay in the sub mapped cell 2, the UE__{B} transmits a measurement report (step S4) after a first time period has elapsed (for example, after waiting for a back off time) since the result of the determination was made (step S3). When the gNB 100 receives the measurement report, the gNB 100 transmits a handover command to the UE__{B} (step S5).

Thereby, the UE__{A} can receive the handover command preferentially and then transmits a RACH to the target cell earliest. Each of the UE__{B} and the UE__{C} can transmit a RACH to the target cell later than the UE__{A.}

According to the operation example 3, a handover timing can be determined by roughly dividing the area where the UEs 200 exist. Therefore, in addition to the effect of the operation example 1, even when the number of the UEs 200 each of which is a handover candidate is large, the processing load in handovers in the gNB 100 and the UEs 200 can be reduced.

### (3.2.4) Operation Example 4

In operation example 4, an example in which a handover process is performed in order from the UE 200 that is closest to the target cell by adding a back off indication to the handover command to be transmitted from the gNB 100 to the UE 200, will be described. The back off indication may be interpreted as an instruction to suppress a handover of the UE 200 to a second cell (target cell) for a certain period of time. The back off indication may be interpreted as an instruction to delay the handover of the UE 200 to the second cell (target cell).

FIG. 11 is a diagram illustrating an example of communication sequence in the operation example 4. The gNB 100 transmits a handover command, which does not include the back off indication, to the UE 200 having a high handover priority (step S1). The gNB 100 transmits a handover command, which includes the back off indication, to another UE 200 whose handover priority is lower than that of the UE 200 (step S2).

The UE 200 having a low priority may be interpreted as the UE 200 for which the distance between a position of the UE 200 and the reference position of the target cell is relatively long (longer than a predetermined threshold). The back off indication may be interpreted as information regarding an indication including a back off time.

When the UE 200 receives the handover command which does not include the back off indication, the UE 200 transmits a RACH to the target cell without waiting for the back off time (step S3).

When the UE 200 receives the handover command which includes the back off indication, the UE 200 waits to transmit a RACH until the back off time has elapsed. When the back off time has elapsed (step S4), the UE 200 transmits the RACH (step S5). In other words, the UE 200 that has received the handover command including the back off indication, can transmit a RACH at a later timing than the UE 200 that has received the handover command not including the back off indication.

According to the operation example 4, the handover timing of each UE 200 can be changed depending on whether or not a back off indication is set, without changing a transmission timing of the handover command. Therefore, in addition to the effect of the operation example 1, even when the number of the UEs 200 each of which is a handover candidate is large, the processing load in handovers in the gNB 100 and the UEs 200 can be reduced.

### (3.2.5) Operation Example 5

In operation example 5, an example in which a handover timing is changed by transmitting a TA report from the UE 200 to the gNB 100 when a mobile cell (Quasi-earth-fixed cell, Earth-moving cell, or the like) moves, will be described.

When the Quasi-earth-fixed cell, the Earth-moving cell, or the like moves, the UE 200 can transmit a TA report. The TA report may be interpreted as a function introduced in rel-17 NTN, in which the UE 200 reports a TA value to the network. The TA value may be interpreted as a value indicating a distance between the gNB 100 (source gNB) and the UE 200. The TA report may be transmitted (triggered) when the TA value is larger than a predetermined threshold value (offsetThresholdTA).

The gNB confirms a tendency of changes in the TA value with reference to the received TA report.

If the TA value has a tendency to decrease over time, the gNB can recognize that the UE 200 is approaching the source gNB, that is, that the UE 200 is moving away from the target cell.

If the TA value has a tendency to increase over time, the gNB can recognize that the UE 200 is moving away from the source gNB, that is, that the UE 200 is approaching the target cell.

The gNB may assign priority to a timing when each UE 200 performs a handover to the target cell based on the characteristics (tendency) of changes in the TA, and then perform a handover process. Specifically, the gNB may perform the handover process preferentially for the UE 200 having a tendency for the TA value to increase, and perform the handover process with a lower priority for the UE 200 having a tendency for the TA value to decrease.

According to the operation example 5, the handover timing of each UE 200 can be changed using the TA value transmitted from each UE 200. Therefore, in addition to the effect of the operation example 1, even when the number of the UEs 200 each of which is a handover candidate is large, the processing load in handovers in the UEs 200 can be reduced.

### (3.2.6) Operation Example 6

In operation example 6, an example in which the UE 200 changes the handover timing based on the tendency of changes in the TA value, will be described.

If the UE 200 has a tendency for the TA value to increase, the UE 200 may perform a handover at a timing when the UE 200 receives a handover command. In other words, as will described later, the UE 200 may perform a handover preferentially in comparison with when the UE 200 has a tendency for the TA value to decrease.

If the UE 200 has a tendency for the TA value to decrease, the UE 200 may perform a handover after waiting for a certain period of time (e.g., back off time) from a timing when the UE 200 receives a handover command. In other words, when the UE 200 has the tendency for the TA value to decrease, the UE 200 may perform a handover with a lower priority.

### (Alt)

The UE 200 may combine the tendency of changes in the TA value with a conditional handover (Conditional Handover: CHO). The UE 200 may configure a conditional handover when the UE 200 receives an RRC message, which includes a parameter for a conditional handover configuration, transmitted from the gNB 100.

If the UE 200 has a tendency for the TA value to increase, the UE 200 may perform a handover when the UE 200 receives a handover command and one or more handover execution conditions are met.

If the UE 200 has a tendency for the TA value to decrease, the UE 200 may perform a handover when a certain period of time (e.g., back off time) has elapsed since the UE 200 received a handover command and when one or more handover execution conditions are met.

According to the operation example 6, each UE 200 can change the handover timing using the TA value. Therefore, in addition to the effect of the operation example 1, it is possible to perform handover autonomously without waiting for an instruction from the gNB 100.

### (3.2.7) Operation Example 7

In operation example 7, an example in which the UE 200 transmits a RACH and RRCReestablishmentRequest to a reconnection destination after waiting for a back off time when a handover fails, will be described.

There is a possibility that a handover to the target cell fails when a failure of communication with the satellite 150 or the like occurs. In this case, if the UE 200 receives a handover command including a back off indication when attempting to reconnect to the target cell, the UE 200 transmits a RACH and RRCReestablishmentRequest to the reconnection destination after a certain period of time has elapsed since the handover command was received.

According to the operation example 7, the handover can be performed after the certain period of time has elapsed since the handover command was received. Therefore, even when the handover fails, the same effect as in the operation example 1 can be obtained at the time of reconnecting.

### (4) Action and Effect

According to the above-described embodiment, the following action and effect can be obtained. Specifically, the base station according to the present embodiment includes: the control unit that controls handovers of terminals, which are located in the first cell formed by the network located above the ground (in the sky), to the second cell adjacent to the first cell; and the transmitting unit that transmits a handover command to the terminals, the handover command being transmitted preferentially to a terminal whose distance from a reference position in the second cell to the terminal is shorter than the threshold value.

This allows the handover process to be performed in order from the UE 200 that is closest to the target cell by comparing a distance from each UE 200 to the target cell with the predetermined threshold value. In other words, a handover timing of the UE 200 far from the target cell can be delayed than a handover timing of the UE 200 close to the target cell. This prevents the plurality of UEs from simultaneously performing handovers to the target cell, which prevents a signaling overhead of a handover command, a RACH, and the like from increasing in a short period of time. As a result, communication delays can be suppressed without wasting frequency or time resources. Furthermore, by comparing the distance with the predetermined threshold value, handovers in the gNB 100 and the UEs 200 can be performed promptly even when the number of the UEs 200 each of which is handover candidates is large.

The base station according to the present embodiment includes: the control unit that controls a handover of a terminal, which is located in the first cell formed by the network located above the ground (in the sky), to the second cell adjacent to the first cell; and the transmitting unit that transmits a back off instruction that suppresses the handover of the terminal to the second cell for a certain period of time.

This allows each UE 200 receiving the handover command to perform a handover when a certain period of time has elapsed since the handover command was received. Therefore, even when the handover fails, the plurality of UEs can be prevented from simultaneously performing handovers to the target cell, which prevents a signaling overhead of a handover command, a RACH, and the like from increasing in a short period of time.

The transmitting unit of the base station according to the present embodiment transmits to the terminal for which the distance is shorter than the threshold value, the handover command not including the back off instruction that suppresses a handover of the terminal to the second cell for the certain period of time, and transmits to another terminal for which the distance is longer than the threshold value, the handover command including the back off instruction.

This allows each UE 200 receiving the handover command to change a handover timing depending on the presence or absence of the back off indication. Therefore, the processing load of each UE 200 can be reduced while preventing the plurality of UEs from simultaneously performing handovers to the target cell.

The terminal according to the present embodiment includes: the control unit that controls a handover of the terminal, which is located in the first cell formed by the network located above the ground (in the sky), to the second cell adjacent to the first cell; and the receiving unit that receives the handover command, the handover command being transmitted preferentially to a terminal whose distance from a reference position in the second cell to the terminal is shorter than the threshold value.

This allows the handover process to be performed in order from the UE 200 that is closest to the target cell by comparing a distance from each UE 200 to the target cell with the predetermined threshold value. In other words, a handover timing of the UE 200 far from the target cell can be delayed than a handover timing of the UE 200 close to the target cell. This prevents the plurality of UEs from simultaneously performing handovers to the target cell, which prevents a signaling overhead of a handover command, a RACH, and the like from increasing in a short period of time. As a result, communication delays can be suppressed without wasting frequency or time resources. Furthermore, by comparing the distance with the predetermined threshold value, handovers in the gNB 100 and the UEs 200 can be performed promptly even when the number of the UEs 200 each of which is handover candidates is large.

The terminal according to the present embodiment includes: the control unit that controls a handover of the terminal, which is located in the first cell formed by the network located above the ground (in the sky), to the second cell adjacent to the first cell; and the receiving unit that receives a back off instruction that suppresses the handover of the terminal to the second cell for a certain period of time.

This allows each UE 200 receiving the handover command to perform a handover when a certain period of time has elapsed since the handover command was received. Therefore, even when the handover fails, the plurality of UEs can be prevented from simultaneously performing handovers to the target cell, which prevents a signaling overhead of a handover command, a RACH, and the like from increasing in a short period of time.

The receiving unit of the terminal according to the present embodiment receives the handover command not including the back off instruction that suppresses the handover of the terminal to the second cell for the certain period of time, the handover command being transmitted to a terminal for which the distance is shorter than the threshold value, or receives the handover command including the back off instruction, the handover command being transmitted to a terminal for which distance is longer than the threshold value.

This allows each UE 200 receiving the handover command to change a handover timing depending on the presence or absence of the back off indication. Therefore, the processing load of each UE 200 can be reduced while preventing the plurality of UEs from simultaneously performing handovers to the target cell.

### (5) Other Embodiments

Although the embodiment has been described, the present invention is not limited to the descriptions of the embodiment, and it is obvious to those skilled in the art that various modifications and improvements can be made.

In the above-described disclosure, configure, activate, update, indicate, enable, specify, and select may be read interchangeably. Similarly, link, associate, correspond, and map may be read interchangeably, and allocate, assign, monitor, and map may also be read interchangeably.

Furthermore, specific, dedicated, UE-specific, and UE-individual may be read interchangeably. Similarly, common, shared, group-common, UE-common, and UE-shared may be read interchangeably.

In this disclosure, a precoding, a precoder, a weight (precoding weight), a Quasi-Co-Location (QCL), a Transmission Configuration Indication state (TCI state), a spatial relation, a spatial domain filter, a transmit power, a phase rotation, an antenna port, an antenna port group, a layer, the number of layers, a rank, a resource, a resource set, a resource group, a beam, a beam width, a beam angle, an antenna, an antenna element, a panel, and the like may be used interchangeably.

Note that the block diagrams (FIG. 4 and FIG. 5) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit)”, a “transmitter”, and the like. The method for implementing each component is not particularly limited as described above.

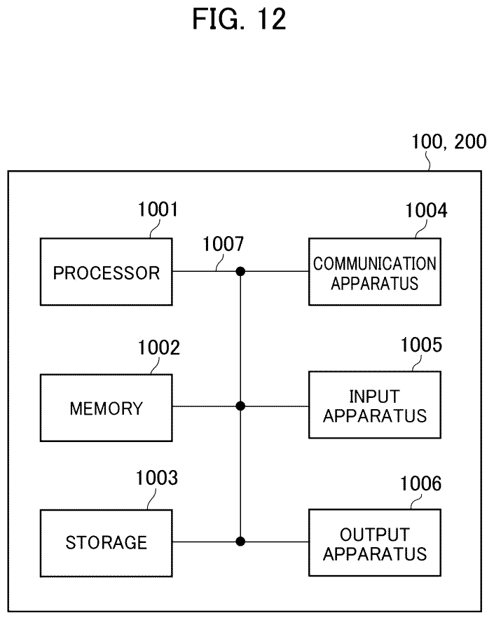

The gNB 100, the UE 200 and the AMF 50 (apparatuses) which are described above may function as a computer that executes the processes of the radio communication method of the present disclosure. FIG. 12 is a diagram to illustrating an example of a hardware structure of the gNB 100 and the UE 200. As illustrated in FIG. 12, the apparatuses may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a unit, and so on can be interchangeably interpreted. The hardware structure of the apparatuses may be configured to include one or more of apparatuses shown in the drawings, or may be configured not to include part of apparatuses.

Each functional block of the apparatuses (see FIG. 4 and FIG. 5) is implemented by any of hardware elements of the computer apparatus or a combination of the hardware elements.

Each function of the apparatuses is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the method according to one embodiment of the present disclosure.

The storage 1003 is a computer-readable recording medium, and may be constituted with, for example, at least one of an optical disk such as a Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and other appropriate storage media. The storage 1003 may be referred to as “auxiliary storage apparatus”. The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the apparatuses may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information in the present disclosure may be implemented by using physical layer signaling (for example, Downlink Control Information (DCI), Uplink Control Information (UCI)), higher layer signaling (for example, RRC signaling, Medium Access Control (MAC) signaling, broadcast information (Master Information Block (MIB), System Information Block (SIB), and so on)), and other signals or combinations of these. Also, RRC signaling may be referred to as an “RRC message”, and can be, for example, an RRC Connection Setup message, an RRC Connection Reconfiguration message, and so on.

The aspects/embodiments illustrated in the present disclosure may be applied to Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate systems, next-generation systems that are enhanced based on these, and the like. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Operations which have been described in the present disclosure to be performed by the gNB 100 may, in some cases, be performed by an upper node of the gNB 100. In a network including one or a plurality of network nodes with the gNB 100, it is clear that various operations that are performed to communicate with the UE 200 can be performed by at least one of the gNB 100 and one or more network nodes (for example, MME, S-GW, and so on may be possible, but these are not limiting) other than the gNB 100. According to the above, a case is described in which there is a single network node other than the gNB 100. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) and wireless technologies (infrared, microwave, etc.), at least one of these wired line technologies and wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and a term required for understanding of the present specification may be replaced by a term having the same or similar meaning. For example, at least one of a channel and a symbol may be a signal (signaling). Further, a signal may be a message. Further, the Component Carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “Base Station (BS)”, a “radio base station”, a “fixed station”, a “NodeB”, an “eNB (eNodeB)”, a “gNB (gNodeB)”, an “access point”, a “transmission point”, a “reception point”, a “transmission/reception point”, a “cell”, a “sector”, a “cell group”, a “carrier”, a “component carrier”, and so on can be used interchangeably. The gNB 100 may be referred to as the terms such as a “macro cell”, a “small cell”, a “femto cell”, a “pico cell”, and so on.

The gNB 100 can accommodate one or a plurality of (for example, three) cells (also called sectors). When the gNB 100 accommodates a plurality of cells, the entire coverage area of the gNB 100 can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of the gNB 100 and a base station subsystem that provides communication services within this coverage.

In the present disclosure, the terms “Mobile Station (MS)”, “user terminal”, “User Equipment (UE)”, and “terminal” may be used interchangeably.

A mobile station may be referred to as a “subscriber station”, a “mobile unit”, a “subscriber unit”, a “wireless unit”, a “remote unit”, a “mobile device”, a “wireless device” a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client”, or some other appropriate terms in some cases.

At least one of the gNB 100 and the mobile station may be referred to as a “transmitting apparatus”, a “receiving apparatus”, a “radio communication apparatus”, and so on. Note that at least one of the gNB 100 and the mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of the gNB 100 and the mobile station also includes an apparatus which does not necessarily move during communication operation. For example, at least one of the gNB 100 and the mobile station may be an Internet of Things (IoT) device such as a sensor.

Furthermore, the gNB 100 in the present disclosure may be interpreted as a user station (user terminal, the same applies hereinafter). For example, each aspect/embodiment of the present disclosure may be applied to the structure that replaces a communication between the gNB 100 and the user station with a communication between a plurality of user stations (for example, which may be referred to as “Device-to-Device (D2D)”, “Vehicle-to-Everything (V2X)”, and the like). In this case, the user stations may have the functions of the gNB 100 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user station in the present disclosure may be interpreted as the gNB 100. In this case, the gNB 100 may have the functions of the user station. A radio frame may be constituted of one or a plurality of frames in the time domain. Each of one or a plurality of frames in the time domain may be referred to as a “subframe”. Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a SubCarrier Spacing (SCS), a bandwidth, a symbol length, a cyclic prefix length, a Transmission Time Interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols less than the number of slots. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, the gNB 100 performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot”, or the like. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “Sub-Carrier Group (SCG)”, a “Resource Element Group (REG)”, a “PRB pair”, an “RB pair” and so on.

Furthermore, a resource block may be constituted of one or a plurality of Resource Elements (REs). For example, one RE may correspond to a radio resource field of one subcarrier and one symbol.

A Bandwidth Part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or coupling between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS”, and may be referred to as a “pilot”, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

“Means” included in the configuration of each of the above apparatuses may be replaced by “parts”, “circuits”, “devices”, etc.

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

As used herein, the term “determining” may encompasses a wide variety of actions. For example, “determining” may be regarded as judging, calculating, computing, processing, deriving, investigating, looking up, search inquiry (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing and the like. That is, “determining” may be regarded as a certain type of action related to determining. Furthermore, “determining” may be regarded as “assuming”, “expecting”, “considering”, and the like.

In this disclosure, the term “A and B are different” may mean “A and B are different from each other”. It should be noted that the term “A and B are different” may mean “A and B are different from C”. Terms such as “separated” or “combined” may be interpreted in the same way as the above-described “different”.

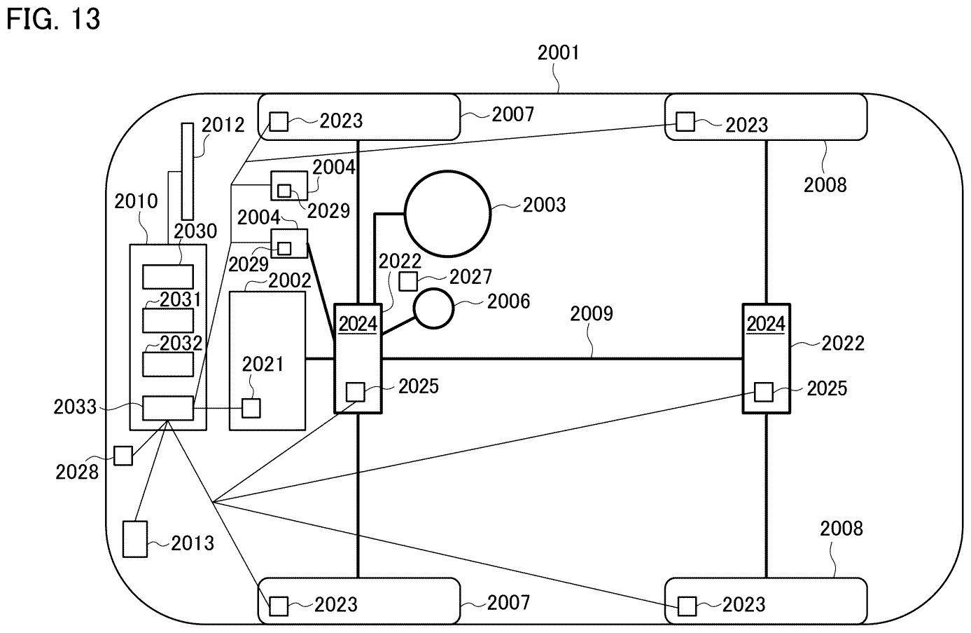

FIG. 13 illustrates an example of a configuration of a vehicle 2001. As illustrated in FIG. 13, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 to 2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021 to 2027 provided in the vehicle 2001. The electronic control unit 2010 may be referred to as an ECU (Electronic control unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 1 by using information obtained from the external device through the communication module 2013 or the like.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, and an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 1 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and sensors 2021 to 2028 provided in the vehicle 1.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, the gNB 100, a mobile station, or the like.

The communication module 2013 transmits the current signal from the current sensor, which is input to the electronic control unit 2010, to external devices through radio communication. In addition, the communication module 2013 transmits to external devices through radio communication, the front or rear wheel rotation signal acquired by the revolution sensor 2022, the front or rear wheel pneumatic signal acquired by the pneumatic sensor 2023, the vehicle speed signal acquired by the vehicle speed sensor 2024, the acceleration signal acquired by the acceleration sensor 2025, the stepped-on accelerator pedal signal acquired by the accelerator pedal sensor 2029, the stepped-on brake pedal signal acquired by the brake pedal sensor 2026, the operation signal of the shift lever acquired by the shift lever sensor 2027, and the detection signal, acquired by the object detection sensor 2028, for detecting an obstacle, a vehicle, a pedestrian, and the like.

The communication module 2013 receives various types of information (traffic information, signal information, inter-vehicle information, etc.) transmitted from the external devices and displays the received information on the information service unit 2012 provided in the vehicle. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 to 2028, etc., mounted in the vehicle 2001.

### Supplementary Note

The terminal of this embodiment may be configured as the terminal described in each of the following items.

### (Item 1)

A base station including: a control unit that controls handovers of terminals, which are located in a first cell formed by a network located above a ground, to a second cell adjacent to the first cell; and a transmitting unit that transmits a handover command to the terminals, the handover command being transmitted preferentially to a terminal whose distance from a reference position in the second cell to the terminal is shorter than a threshold value.

### (Item 2)

A base station including: a control unit that controls a handover of a terminal, which is located in a first cell formed by a network located above a ground, to a second cell adjacent to the first cell; and a transmitting unit that transmits a back off instruction that suppresses the handover of the terminal to the second cell for a certain period of time.

### (Item 3)

The base station according to claim 1, wherein the transmitting unit transmits to the terminal for which the distance is shorter than the threshold value, the handover command not including a back off instruction that suppresses a handover of the terminal to the second cell for a certain period of time, and transmits to another terminal for which the distance is longer than the threshold value, the handover command including the back off instruction.

### (Item 4)

A terminal including: a control unit that controls a handover of the terminal, which is located in a first cell formed by a network located above a ground, to a second cell adjacent to the first cell; and a receiving unit that receives a handover command, the handover command being transmitted preferentially to a terminal whose distance from a reference position in the second cell to the terminal is shorter than a threshold value.

### (Item 5)

A terminal including: a control unit that controls a handover of the terminal, which is located in a first cell formed by a network located above a ground, to a second cell adjacent to the first cell; and a receiving unit that receives a back off instruction that suppresses the handover of the terminal to the second cell for a certain period of time.

### (Item 6)

The terminal according to claim 5, wherein the receiving unit receives the handover command not including a back off instruction that suppresses the handover of the terminal to the second cell for the certain period of time, the handover command being transmitted to a terminal for which the distance is shorter than the threshold value, or the handover command including the back off instruction, the handover command being transmitted to a terminal for which the distance is longer than the threshold value.

The present embodiments may be applied to an SN (Secondary Node) mobility (PSCell change) in NTN Dual connectivity.

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### EXPLANATION OF REFERENCE NUMERALS

10 radio communication system
20 NG-RAN
30 core network
40 radio communication node
100 gNB
100X NTN gateway
110 receiving unit
120 transmitting unit
130 control unit
150 satellite
200 UE
210 radio signal transmitting and receiving unit
220 amplifier unit
230 modulation and demodulation unit
240 control signal and reference signal processing unit
250 encoding and decoding unit
260 data transmitting and receiving unit
270 control unit
310 receiving unit
320 transmitting unit
330 control unit
1001 processor
1002 memory
1003 storage
1004 communication apparatus
1005 input apparatus
1006 output apparatus
1007 bus
2001 vehicle
2002 drive unit
2003 steering unit
2004 accelerator pedal
2005 brake pedal
2006 shift lever
2007 front wheel
2008 rear wheel
2009 axle
2010 electronic control unit
2012 information service unit
2013 communication module
2021 current sensor
2022 revolution sensor
2023 pneumatic sensor
2024 vehicle speed sensor
2025 acceleration sensor
2026 brake pedal sensor
2027 shift lever sensor
2028 object detection sensor
2029 accelerator pedal sensor
2030 driving support system unit
2031 microprocessor
2032 memory (ROM, RAM)
2033 communication port

1. A base station comprising:
a control unit that controls handovers of terminals, which are located in a first cell formed by a network located above a ground, to a second cell adjacent to the first cell; and
a transmitting unit that transmits a handover command to the terminals, the handover command being transmitted preferentially to a terminal whose distance from a reference position in the second cell to the terminal is shorter than a threshold value.

2. A base station comprising:
a control unit that controls a handover of a terminal, which is located in a first cell formed by a network located above a ground, to a second cell adjacent to the first cell; and
a transmitting unit that transmits a back off instruction that suppresses the handover of the terminal to the second cell for a certain period of time.

3. The base station according to claim 1, wherein
the transmitting unit transmits to the terminal for which the distance is shorter than the threshold value, the handover command not including a back off instruction that suppresses a handover of the terminal to the second cell for a certain period of time, and transmits to another terminal for which the distance is longer than the threshold value, the handover command including the back off instruction.

4. A terminal comprising:
a control unit that controls a handover of the terminal, which is located in a first cell formed by a network located above a ground, to a second cell adjacent to the first cell; and
a receiving unit that receives a handover command, the handover command being transmitted preferentially to a terminal whose distance from a reference position in the second cell to the terminal is shorter than a threshold value.

5. A terminal comprising:
a control unit that controls a handover of the terminal, which is located in a first cell formed by a network located above a ground, to a second cell adjacent to the first cell; and
a receiving unit that receives a back off instruction that suppresses the handover of the terminal to the second cell for a certain period of time.

6. The terminal according to claim 4, wherein
the receiving unit receives
the handover command not including a back off instruction that suppresses the handover of the terminal to the second cell for a certain period of time, the handover command being transmitted to a terminal for which the distance is shorter than the threshold value, or
the handover command including the back off instruction, the handover command being transmitted to a terminal for which the distance is longer than the threshold value.
